(19) United States
(12) Patent Application Publication
(10) Pub. No.: US 2010/0204013 A1
(43) Pub. Date: Aug. 12, 2010

(54) Actual roadway condition simulation system and method

(76) Inventors: Yu-Kai Chen, Chiayi City (TW); Chau-chung Song, Chiayi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/588,984

(22) Filed: Nov. 4, 2009

(30) Foreign Application Priority Data
Feb. 11, 2009 (TW) 98104296

(51) Int. Cl. A63B 21/00; G01C 21/00

(52) U.S. Cl. 482/5; 701/213

(57) ABSTRACT

The present invention discloses an actual roadway condition simulation system and method. The system includes a driving recoding device, a computer and a training platform. The computer receives and calculates data filed in the driving recording device and then transmits the data to the training platform, and the training platform produces resistance strength. The method includes: the driving recording device receiving a GPS positing packet signal and accessing data to be filed, and then transmitting the data to the computer; the computer displaying an electronic map and a driving path track; and the training platform producing resistance strength, thereby simulating the variations of the resistance strength of an actual path and achieving the effect of simulating actual roadway condition.

### BACKGROUND OF THE INVENTION

1. Field of the Invention

The present invention relates to a simulation system, and more particularly to an actual roadway condition simulation system via which users can experience a resistance situation.

2. Description of Related Art

Users can adjust and control resistance levels for conventional fitness bicycles on control panels, and the disadvantage is that resistance of conventional fitness bicycles can only be changed by manual control, so resistance variations of actual roadway condition cannot be simulated.

### SUMMARY OF THE INVENTION

The problem that the present invention needs to solve is that conventional fitness bicycles are generally in-built resistance levels and cannot simulate resistance variations of actual roadway condition.

An object of the present invention is to provide an actual roadway condition simulation system and method which needn't control resistance levels via a control panel and can repeatedly experience actual roadway condition unlimitedly, freedom from the influence of climate.

To achieve the above-mentioned object, an actual roadway condition simulation system in accordance with the present invention is provided. The system includes a driving recoding device, a computer and a training platform, wherein the driving recoding device receives a GPS positioning packet signal and converts the GPS positioning packet signal into desired data which are accessed and filed; the computer receives the desired data, compares the data and convert the data into a slope value, that is, a corresponding resistance value; and the training platform receives the slope value and the corresponding resistance value from the computer and produces resistance strength.

To achieve the above-mentioned object, an actual roadway condition simulation method in accordance with the present invention is provided. The method includes: a driving recording device receiving a GPS positing packet signal; the driving recording device transmitting the accessed and filed data to the computer; the computer displaying an electronic map and a driving path track, outputting a resistance value; and the training platform producing resistance strength basing on the desired resistance value.

When users pass by a path outside and record GPS positioning data of the path via the driving recording device. The positioning data includes time, height, longitude and latitude. Then the data accessed in the driving recording device is transmitted to the computer, and the computer displays the electronic map and the driving path track, compares the height difference to obtain the slope value of the actual roadway condition and transmits the slope value and the corresponding resistance value to a controller of the training platform. The controller produces a resistance signal basing on the resistance value to control a magnetic resistance device to produce corresponding resistance strength.

Consequently, the present invention doesn't need to control resistance levels via a panel according to a path planed by users, and the resistance strength can vary with the slope values of the actual roadway condition, thereby simulating the resistance condition of the actual roadway condition and repeatedly simulating the path unlimitedly, freedom from the influence of climate. The present invention can also be used in training before bicycle matches.

### BRIEF DESCRIPTION OF THE DRAWINGS

FIG. 1 is a schematic view of an embodiment of an actual roadway condition simulation system according to the present invention;

FIG. 2 is a block diagram of an embodiment of the actual roadway condition simulation system according to the present invention;

FIG. 3 is a flow chart of an embodiment of an actual roadway condition simulation method according to the present invention;

FIG. 4 is a flow chart of an embodiment of accessing data to be filed in the actual roadway condition simulation method according to the present invention; and

FIG. 5 is a flow chart of an embodiment of displaying an electronic map and a driving path track in the actual roadway condition simulation method according to the present invention.

### DETAILED DESCRIPTION OF THE PREFERRED EMBODIMENTS

The present invention can combine a driving recording device with a training platform and provide resistance variations adjusted according to a recorded path via computer calculation, and the present invention needn't control resistance levels etc. via a control panel to achieve the effect of actual roadway condition simulation.

For more detailed description and explanation, please refer to the following detailed description and drawings related the present invention to more clearly disclose technical contents, advantages and efficacy of the present invention.

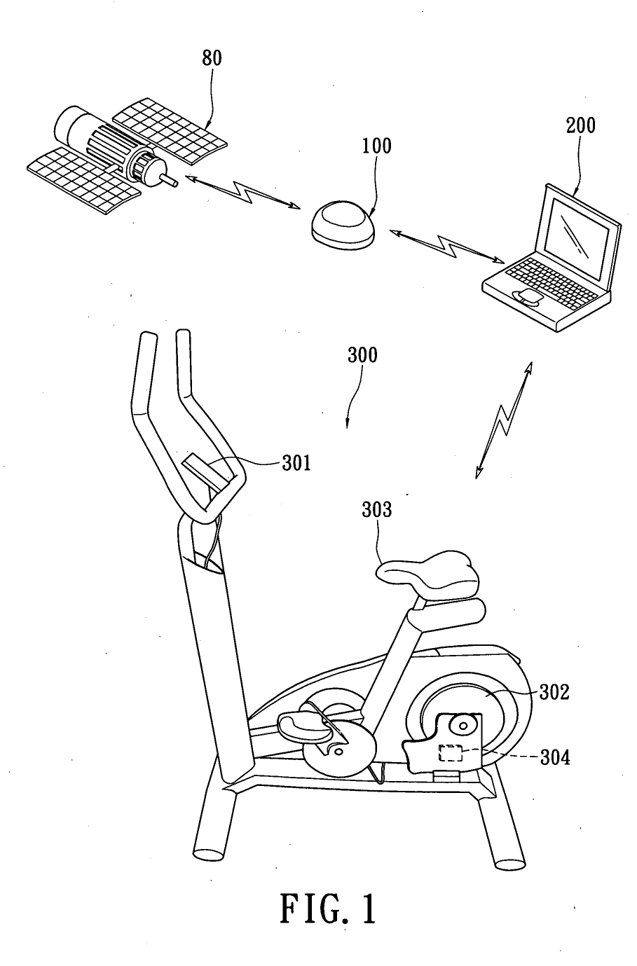

Firstly, please refer to FIG. 1 illustrating an embodiment of an actual roadway condition simulation system according to the present invention. The system includes a driving recording device 100, a computer 200 and a training platform 300. The driving recoding device 100 is used for receiving a GPS positioning packet signal from a satellite 80 and converting the GPS positioning packet signal into desired data which are accessed and filed. The desired data include time, height, longitude and latitude. The computer 200 is used for receiving the accessed and filed data of the driving recording device 100, comparing the data and converting them into a slope value and a corresponding resistance value. The training platform 300 includes a controller 301, a magnetic resistance device 302, a loading device 303 and a detecting unit 304. The controller 301 is disposed on the loading device 303 for receiving the time, the corresponding slope value and resistance value from the computer 200. The magnetic resistance device 302 is electrically connected with the controller 301 for receiving the slope value and the resistance value from the controller 301 and producing resistance strength basing on the resistance value, that is, the greater the slope value is, the greater the resistance strength is; on the contrary, the smaller the slope value is, the smaller the resistance strength is. The detecting unit 304 is connected with the loading device 303, and the detecting unit 304 is a rotating speed detector, the loading device 303 is a magnetic-control fitness bicycle, and the rotating speed detector detects the rotating speed of the fitness bicycle.

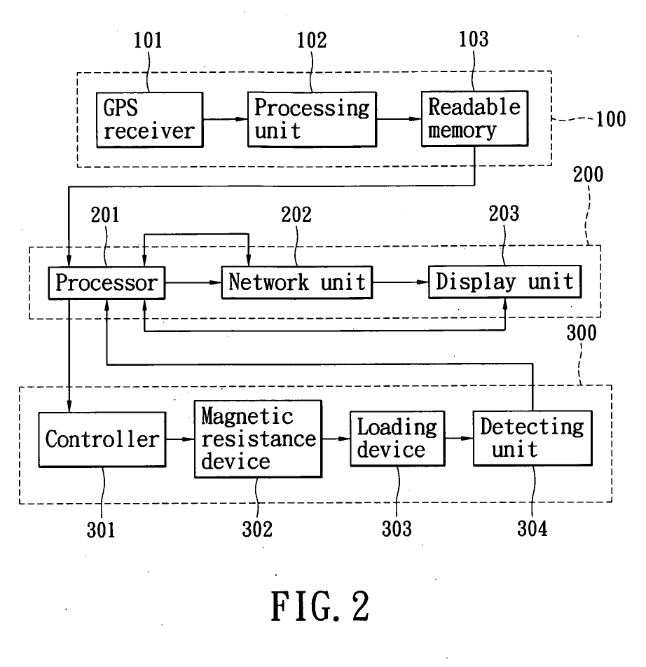

Please refer to FIG. 2 illustrating a block diagram of an embodiment of the actual roadway condition simulation system according to the present invention. The system includes a driving recording device 100, a computer 200 and a training platform 300. The driving recording device 100 includes a GPS receiver 101, a processing unit 102 and a readable memory 103, wherein the GPS receiver 101 is a satellite GPS positioning receiver. The computer 200 includes a processor 201, a network unit 202 and a display unit 203. The training platform 300 includes a controller 301, a magnetic resistance device 302, a loading device 303 and a detecting unit 304, wherein the detecting unit 304 at least includes a rotating speed detector, and the loading device 303 is a magnetic-control fitness bicycle.

When users pass by a path outside, the GPS receiver 101 is used for receiving the GPS positioning packet signal from the satellite 80; the processing unit 102 is connected with the GPS receiver 101 for selecting a desired packet signal from the GPS positioning packet signal and converting it into the desired data; and the readable memory 103 is connected with the processing unit 102 for storing the desired data. The computer 200 receives the data accessed and filed by the driving recording device 100, compares the data via the processor 201, loads an electronic map via the network unit 202, displays the electronic map and a driving recording track via the display unit 203, and calculates the slope value and the resistance value and outputs them in a time sequence. The controller 301 is connected with the computer 200 for receiving the slope value and the resistance value from the computer 200 and producing a resistance signal basing on the resistance value. The magnetic resistance device 302 receives the resistance signals from the controller 301 and produces resistance strength basing on the resistance signal. The loading device 303 receives the resistance strength form the magnetic resistance device 302 providing for users as a platform and then works. The detecting unit 304 is connected with the loading device 303 and the computer 200 for detecting the condition of the loading device 303 and transmitting the detected data to the computer 200. The computer 200 receives the data accessed and filed by the driving recording device 100 via a first transmission interface (not shown) which may be a wire transmission interface or a wireless transmission interface, for example, USB, RS-232 or wireless detection communication modules such as ZigBee. The training platform 300 transmits the data to the computer 200 and receives the data from the computer 200 via a second transmission interface (not shown) which may be a wire transmission interface or a wireless communication module, for example, USB, RS-232 or wireless detection communication modules such as ZigBee.

In one embodiment, the detecting unit 304 includes a power output sensor, which is installed in the shaft of loading device 303 for detecting the wheel speed, the rotation speed of the pedal or the chain speed. In particular, the rotation speed of the pedal is converted to the torque and transmitted to the computer 200 via the second transmission interface. Thus, the computer 200 counts the power consumption of the users.

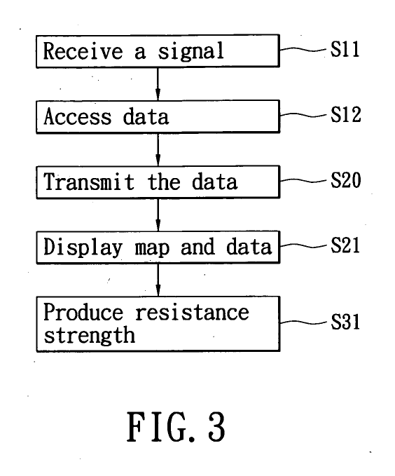

Please refer to FIG. 3 illustrating a flow chart of an embodiment of an actual roadway condition simulation method according to the present invention. The method includes: the driving recording device 100 receiving a GPS positioning packet signal (S11), accessing data to be filed (S12) and transmitting the filed data to the computer 200 via the first transmission interface (not shown) (S20); the computer 200 displaying an electronic map and a driving track and outputting a resistance value (S21); the training platform 300 producing a resistance strength basing on the resistance value (S31), wherein the first transmission interface (not shown) may be a wire transmission interface or a wireless transmission interface, for example, USB, RS-232 or wireless detection communication modules such as ZigBee.

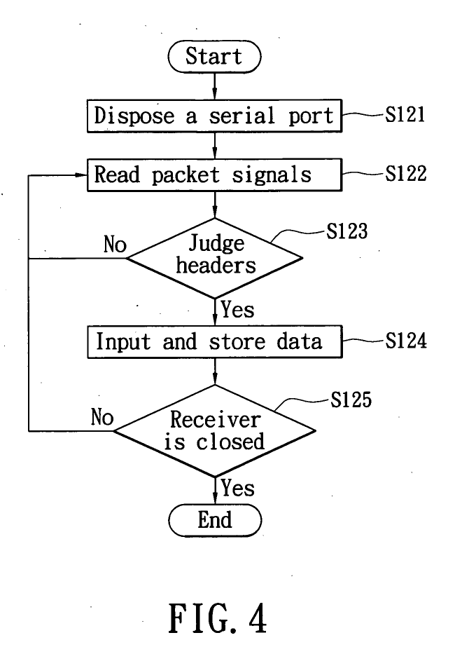

Please refer to FIG. 4 illustrating a flow chart of an embodiment of accessing data to be filed in an actual roadway condition simulation method according to the present invention, which is achieved by the processing unit 102 of the driving recording device 100 executing a program of the system, a network unit 202 and display unit 203 using the graphical program LabVIEW®, The method includes: disposing a serial port (S121); reading all kinds of packet signals (S122); judging if the headers of the packet signals accord with the demand of the system (S123); and importing the packet signals and converting them into the desired data (S124), wherein the desired data include time, height, longitude and latitude. The program doesn't be over until the receiver 101 is closed (S125), otherwise; it returns to reading all kinds of packet data (S122).

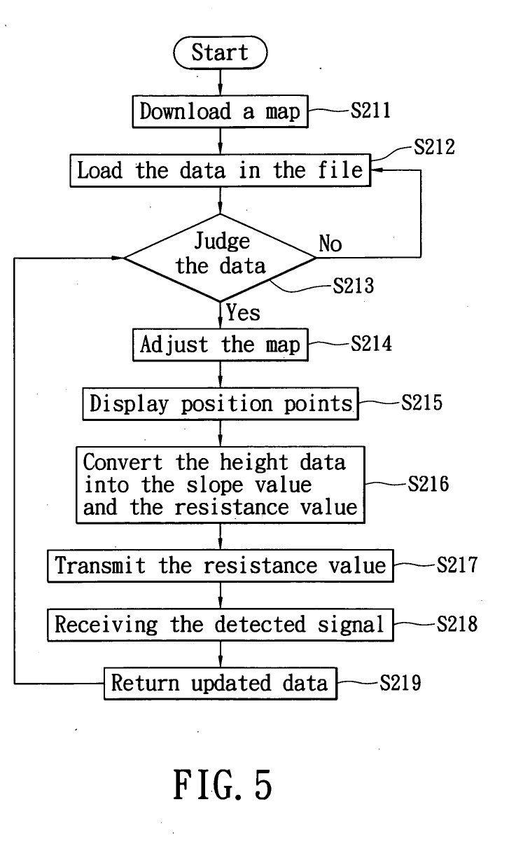

Please refer to FIG. 5 illustrating a flow chart of an embodiment of displaying an electronic map and a driving path track in an actual roadway condition simulation method according to the present invention, which is completed by the processor 201 of the computer 200 executing a program of the system, the network 202 and the display unit 203. The program may be a graphical program such as LabVIEW®. The method includes: downloading an electronic map from a network and starting the electronic map (S211); loading the filed data from the driving recording device 100; judging if the downloaded electronic map accord with the longitude and latitude data of the filed data (S213); adjusting the window of the electronic map and the orientation angle of the window on the displaying unit 203 (S214); displaying a position points and labeling the data of the positioning points on the map according to the loaded data (S215); the processor 201 converting the height data into the slope value and the resistance value (S216); transmitting the resistance value (S217); receiving the detected signal from the detecting unit 304 (S218) and returning updated positioning point data (S219).

The detecting unit 304 at least includes a rotating speed detector for detecting the rotating speed of the loading device 303 and transmitting the rotating speed signal into the computer 200 via the second transmission interface (not shown). The computer 200 converts the rotating speed signal into speed data, displays the speed data on the display unit 203 and calculates the simulating distance which the loading, device 303 passes by (S218). And then, the computer 200 reloads next positioning data (S219) and judges if the downloaded electronic map accord with the longitude and latitude data of the loaded next data (S213), and then adjusts the window of the electronic map and the orientation angle of the window (S214); redisplaying position points and labeling the data of the positioning points on the electronic map according to the loaded next data (S215). Based on reloading next positioning data continuously, a dynamic driving track can be displayed. With the variation of the track, the computer 200 converts the height data of different positioning points into the slope values and the resistance values (S216), that is, the difference of two height data divided by the simulating passed distance is the slope value, that is, the corresponding resistance value. The computer 200 transmits the calculated slope value and resistance value to the training platform 300 in the time sequence (S217). The controller 301 of the training platform 300 receives the resistance value and converts the resistance value into the resistance signal for controlling the magnetic resistance device 302 to produce resistance strength. The greater the slope value is, the greater the resistance strength produced by the magnetic resistance device 302 is and the greater the force needed when users step on the loading device 303 is; on the contrary, the smaller the slope value is, the smaller the resistance strength produced by the magnetic resistance device 302 is and the smaller the force needed when users step on the loading device 303 is.

The detecting unit 304 may convert the resistance value into a signal for calorie consumption and transmit the signal for calorie consumption into the computer 200, and then the display unit 203 displays the data for calorie consumption.

In one embodiment, the detecting unit 304 includes a power output sensor, which is installed in the shaft of loading device 303 for detecting the wheel speed, the rotation speed of the pedal or the chain speed. In particular, the rotation speed of the pedal is converted to the torque and the torque detected signal is transmitted to the computer 200 via the second transmission interface. Thus, the computer 200 counts the power consumption of the users.

The detecting unit 304 further includes a heartbeat detector for detecting users' heartbeats and transmitting the heartbeat detected signal into the computer 200, and then the display unit 203 displays the heartbeat data.

Consequently, the present invention can combine the driving recording device with the training platform, calculate and judge data according to computer executive programs, keep on loading next data basing on the detecting unit detecting the rotating speed of the loading device, calculate the slope values and the corresponding resistance values and output them by the computer, and then control the resistance strength of the training platform, so that the resistance strength can vary with the slope values of the actual roadway condition, thereby simulating the variation of the resistance values of the actual roadway condition recorded by the driving recording device and experiencing actual condition of a path unlimitedly, freedom from the influence of climate. The present invention can also be used in training before bicycle matches.

Another embodiment of the actual roadway condition simulation system of the present invention further includes a power supply system (not shown) disposed on a rotating shaft of the loading device 303. The power supply system includes an electric generator (not shown) and an electrical storage device (not shown). The electric generator (not shown) produces electric energy basing on the rotating speed of the loading device (303) and the electrical storage device (not shown) stores the electric energy and supplies the electric energy for the controller 301, the magnetic resistance device 302 and the detecting unit 304.

What are disclosed above are only the specification and the drawings of the preferred embodiments of the present invention and it is therefore not intended that the present invention be limited to the particular embodiments disclosed. It will be understood by those skilled in the art that various equivalent variations may be made depending on the specification and the drawings of the present invention without departing from the slope of the present invention.

What is claimed is:

1. An actual roadway condition simulation system, comprising:
a driving recoding device, receiving a GPS positioning packet signal and converting the GPS positioning packet signal into desired data which are accessed and filed;
a computer, receiving the data filed in the driving recording device, comparing the filed data and converting the filed data into a slope value and a resistance value; and
a training platform, receiving the filed data and the converted resistance value signal from the computer and producing resistance strength basing on the signal.

2. The actual roadway condition simulation system as claimed in claim 1, wherein the computer receives the data from the driving recording device via a first transmission interface which is a wire transmission interface or a wireless detection communication module.

3. The actual roadway condition simulation system as claimed in claim 1, wherein the training platform receives the filed data and the converted resistance value signal from the computer via a second transmission interface which is a wire transmission interface or a wireless detection communication module.

4. The actual roadway condition simulation system as claimed in claim 1, wherein the driving recording device includes:
a receiver, receiving the GPS positioning packet signal from a satellite;
a processing unit, connected with the receiver for selecting a desired packet signal from the GPS positioning packet signal and converting the desired packet signal into the desired data; and
a readable memory, connected with the processing unit for storing the desired data.

5. The actual roadway condition simulation system as claimed in claim 4, wherein the receiver is a satellite GPS positioning receiver.

6. The actual roadway condition simulation system as claimed in claim 1, wherein the computer includes:
a processor, calculating and comparing the data from the driving recording device and the training platform;
a network unit, connected with the processor for loading an electronic map; and
a display unit, connected with the processor for displaying the electronic map and a driving path track.

7. The actual roadway condition simulation system as claimed in claim 6, wherein the computer has an in-built program for starting the electronic map and loading the data accessed and filed by the driving recording device.

8. The actual roadway condition simulation system as claimed in claim wherein the training platform includes:
a controller, receiving the resistance value from the computer and producing a resistance signal basing on the resistance value;
a magnetic resistance device, connected with the controller for receiving the resistance signal from the controller and producing the resistance strength basing on the resistance signal;
a loading device, connected with the magnetic resistance device for receiving the resistance strength from the magnetic resistance device and providing for users as an operation platform; and
a detecting unit, connected with the loading device and the computer for detecting condition of the loading device and transmitting detected data to the computer.

9. The actual roadway condition simulation system as claimed in claim 8, wherein the loading device is a magnetic-control fitness bicycle.

10. The actual roadway condition simulation system as claimed in claim 8, wherein the detecting unit at least includes a rotating speed detector for detecting rotating speed of the loading device.

11. The actual roadway condition simulation system as claimed in claim 8, wherein the detecting unit at least includes a power output sensor for detecting the torque of the loading device.

12. The actual roadway condition simulation system as claimed in claim 8, wherein the detecting unit transmits the detected data to the computer via a second transmission interface which is a wire transmission interface or a wireless detection communication interface.

13. A method of simulating actual roadway condition, which is used for calculating and controlling resistance strength produced by a training platform via a driving recording device and a computer, the method comprising the steps of:
the driving recording device receiving a GPS positing packet signal;
the driving recording device accessing data to be filed;
transmitting the filed data to the computer;
the computer displaying an electronic map and a driving path track, calculating a slope value and outputting a resistance value; and
the training platform producing resistance strength basing on the resistance value.

14. The method as claimed in claim 13, wherein the step of the driving recording device accessing data to be filed includes the steps of:
disposing a serial port;
reading all kinds of packet signals;
judging if headers of the packet signals accord with the demand of the system; and
importing and converting the packet signals into desired data.

15. The method as claimed in claim 14, wherein the desired data include time, height, longitude and latitude.

16. The method as claimed in claim 13, wherein the step of the computer displaying the electronic map and the driving path track, calculating the slope value and outputting the resistance value includes the steps of:
starting and loading the electronic map;
loading the filed data;
comparing the electronic map and the filed data;
adjusting a window of an electronic map and an orientation angle of the window;
displaying a positioning point and labeling the filed data;
converting the filed data into the slope value and the resistance value according to the height data;
receiving a detected signal; and
returning updated positioning point data.

17. The method as claimed in claim 16, wherein the detected signal at least includes a rotating speed detected signal, a heartbeat detected signal or and a signal for calorie consumption converted by the resistance value.

18. The method as claimed in claim 16, wherein the detected signal at least includes a torque detected signal for counting the power consumption of the users.

19. The method as claimed in claim 16, wherein the step of returning updated positioning point data includes the steps of:
converting the rotating speed detected signal into speed data;
calculating a simulating distance which the loading device passes basing on the speed data; and
comparing next data basing on the distance.

20. The method as claimed in claim 13, wherein the step of the training platform producing resistance strength basing on the resistance value includes the steps of:
receiving the resistance value;
converting the resistance value into a resistance signal; and
receiving the resistance signal and producing resistance strength.
